(19) United States
(12) Patent Application Publication
(10) Pub. No.: US 2024/0321716 A1
(43) Pub. Date: Sep. 26, 2024

(54) Electronic Devices Having Oval Power Delivery Pads

(71) Applicant: Altera Corporation, San Jose, CA (US)

(72) Inventors: Md Altaf Hossain, Portland, OR (US); Atul Maheshwari, Portland, OR (US); Mahesh Kumashikar, Bangalore (IN); Ankireddy Nalamalpu, Portland, OR (US); Krishna Bharath Kolluru, Portland, OR (US)

(73) Assignee: Altera Corporation, San Jose, CA (US)

(21) Appl. No.: 18/680,058

(22) Filed: May 31, 2024

(51) Int. Cl. H01L 23/498; G06F 30/31; G06F 115/10

(52) U.S. Cl. CPC H01L 23/49838; G06F 30/31; G06F 2115/10

(57) ABSTRACT

An electronic device includes conductive pads that are formed on a surface of the electronic device. Each of the conductive pads has an oval shape. The conductive pads are coupled to deliver at least one of a power supply voltage or a ground voltage between an external device and the electronic device.

### TECHNICAL FIELD

The present disclosure relates to electronic devices, and more particularly, to electronic devices that have oval power delivery pads.

### BACKGROUND

Integrated circuits (ICs) are often housed in integrated circuit (IC) packages. An IC package contains conductors that couple an integrated circuit (IC) to conductive pads exposed on a surface of the IC package. The conductive pads on the surface of the IC package are typically coupled to a circuit board through conductive connections, such as conductive balls.

### BRIEF DESCRIPTION OF DRAWINGS

FIG. 1A is a diagram that depicts an example of an electronic device having non-circular elliptically shaped conductive power pads.

FIG. 1B is a diagram that depicts another example of an electronic device having non-circular elliptically shaped conductive power pads.

FIG. 1C is a diagram that depicts yet another example of an electronic device having non-circular elliptically shaped conductive power pads.

FIG. 2 is a diagram that depicts a top down view of examples of non-circular elliptically shaped conductive power pads, power through vias, and rectangularly shaped conductive pads for capacitors in a circuit board.

FIG. 3 is a diagram that depicts a cross sectional view of an example of a circuit system that includes an integrated circuit (IC) package coupled to a circuit board.

FIG. 4 is a diagram of an illustrative example of a configurable integrated circuit (IC).

FIG. 5 illustrates a block diagram of a system that can be used to implement a circuit design to be programmed into a programmable logic device using design software.

FIG. 6 is a diagram that depicts an example of a programmable logic device that includes fabric dies and base dies that are connected to one another via microbumps.

FIG. 7 is a block diagram illustrating a computing system configured to implement one or more aspects of the embodiments described herein.

### DETAILED DESCRIPTION

According to some examples disclosed herein, an electronic device includes conductive power pads that are formed on a surface of the electronic device. The electronic device can be, as examples, an integrated circuit (IC) die, a package substrate of an integrated circuit package, or a circuit board. Each of the conductive power pads has an oval shape (e.g., a non-circular elliptical shape) on the surface of the electronic device from a top down perspective. The conductive power pads can be coupled through conductive connections to components of an integrated circuit (IC) package. One or more power supply voltages and/or ground voltages can be transmitted through the oval shaped conductive power pads. The oval shaped conductive power pads can increase power delivery to the IC package, signal integrity, and the number of the conductive connections to the IC package. The number and the configuration of the oval shaped conductive power pads on the surface of the electronic device can be adjusted based on the IC package form factor and usage model. The dimensions of the oval shaped power pads can vary based on the IC package size, the usage model, etc. As used herein, an oval shape is a non-circular closed loop having a major axis that is longer than the minor axis of the closed loop.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the terms “connected” and “connection” mean a direct electrical connection between the circuits that are connected, without any intermediary devices. The terms “coupled” and “coupling” mean either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

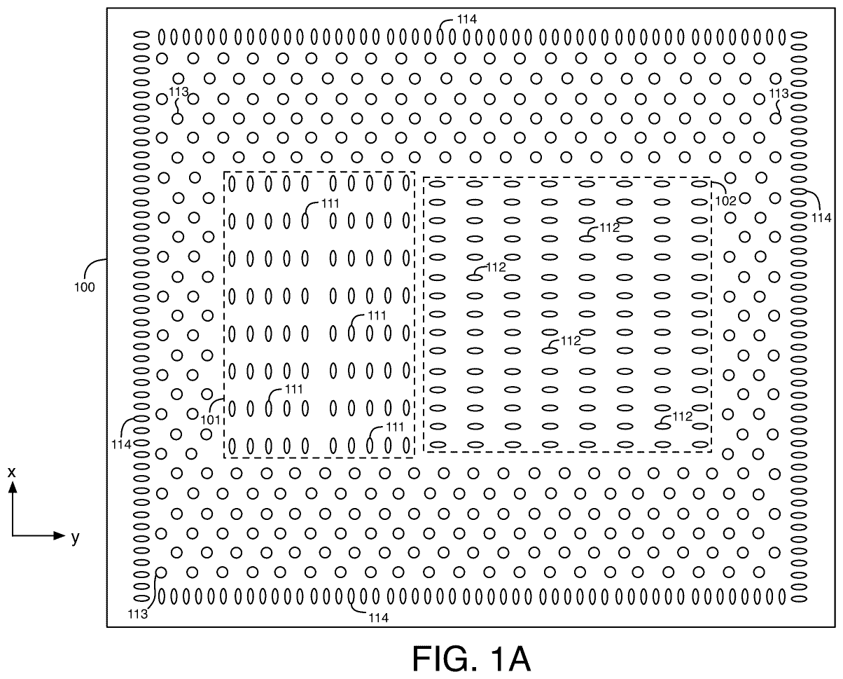

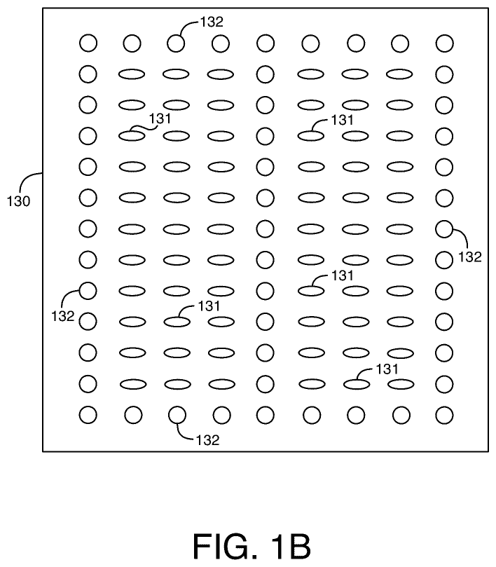

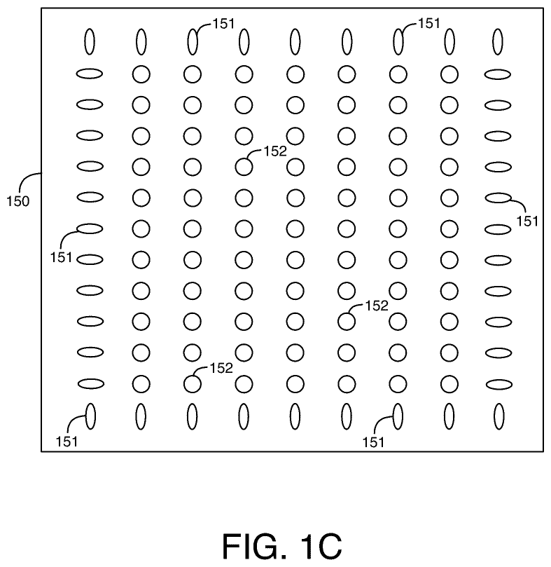

FIG. 1A is a diagram that depicts an example of an electronic device 100 having non-circular elliptically shaped conductive power pads. The electronic device 100 can be, as examples, a circuit board containing multiple layers of material (e.g., a printed circuit board), an integrated circuit (IC) die, a package substrate in an integrated circuit package, or an interposer. The electronic device 100 can be used to transmit, store, and/or process electronic signals and to transmit and/or receive power supply and/or ground voltages. The electronic device 100 is also referred to as an electrical device.

The electronic device 100 includes several conductive pads that are shown in the view of Figure (FIG. 1A. For example, electronic device 100 includes conductive pads 111, conductive pads 112, conductive pads 113, and conductive pads 114. Only a subset of the conductive pads 111-114 are labeled with reference numerals in FIG. 1A to simplify the drawing. Each of the conductive pads 111-114 is formed on a surface of the electronic device 100. Thus, each of the conductive pads 111-114 is exposed on the surface of the electronic device 100 and can be used as a point of electrical contact from electronic device 100 to another electrical device, such as an IC package, package substrate, IC die, or circuit board. Each of the conductive pads 111-114 is made of conductive material, such as metal and/or metallic alloys.

Each of the conductive pads 113 is a circular shaped pad in the view of FIG. 1A. Each of the conductive pads 111, 112, and 114 is shaped as a non-circular ellipse having two foci F1 and F2 that are in different locations (F1≠F2) in the view of FIG. 1A. Thus, each of the conductive pads 111, 112, and 114 has the shape of an ellipse having a major axis through two foci F1 and F2 of the ellipse that is longer than a minor axis of the ellipse. The minor axis of the elliptical shape of each pad is perpendicular to the major axis and runs through the center of the elliptical shape. As used herein, a non-circular ellipse is a type of oval.

When the electronic device 100 is coupled in a circuit system, one or more power supply voltages and/or ground voltages can be transmitted through the conductive pads 111 and 112 into and/or out of the electronic device 100. Thus, conductive pads 111-112 function as power supply voltage and/or ground voltage delivery pads for delivering one or more power supply voltages and/or one or more ground voltages and associated power supply and/or ground current to and/or from the electronic device 100.

The electronic device 100 includes 80 conductive pads 111 that are formed in a first rectangular region 101 located in the center left of the surface of the electronic device 100. The electronic device 100 also includes 120 conductive pads 112 that are formed in a second rectangular region 102 located in the center right of the surface of the electronic device 100. 80 pads 111 and 120 pads 112 are shown in FIG. 1A merely as an example. According to various examples, an electronic device can have any number of non-circular elliptically shaped conductive pads arranged in any configuration on a surface of the electronic device for power supply voltage and/or ground voltage delivery.

Each of the conductive pads 111 in region 101 has a major axis in the x direction shown in FIG. 1A and a minor axis in the y direction shown in FIG. 1A. Each of the conductive pads 112 in region 102 has a major axis in the y direction shown in FIG. 1A and a minor axis in the x direction shown in FIG. 1A. The x and y directions are perpendicular. This perpendicular orientation of the major axes of the pads helps to increase solder joint reliability for conductive connections that are coupled between pads 111-112 and another device. However, according to various examples, an electronic device can have any number of non-circular elliptically shaped conductive power pads with major and minor axes arranged in any orientation on a surface of the electronic device.

According to various examples, oval (e.g., non-circular elliptically shaped) conductive pads, such as pads 111-112, on a surface of an electronic device are used for power supply voltage and/or ground voltage delivery. Because the conductive pads are oval shaped, the conductive pads can be placed closer together on the surface of the device, without violating design rules. As a result, the oval shaped conductive power pads reduce the form factors of the electronic device and any IC package coupled to the conductive pads. For this reason, oval shaped conductive power pads are useful for reducing cost and/or increasing power delivery in electronic devices having limited space for input/output pads and for large power delivery systems. In addition, oval shaped conductive pads used for power delivery on an electronic device can maintain solder joint reliability and electrical performance.

Any potential warpage or coplanarity issues of electronic device 100 can be reduced or eliminated by adjusting the dimensions (e.g., in the x and y directions) of the non-circular elliptically shaped conductive pads 111-112 based on the form factor, the usage model, and other attributes of the electronic device 100. Special attention can be given to high stress regions of the electronic device, such as IC die shadow areas. Instead of using circular conductive power pads, electronic device 100 includes several non-circular elliptically shaped conductive power delivery pads (i.e., conductive pads 111-112) that are equal to, or better than, circular pads for shocks, vibrations, and temperature cycling of electronic device 100. If the routing direction of the power supply and/or ground voltages changes as a result of changes to the system routing strategy, the IC package floorplan, etc., the definition and orientation (in any direction) of the conductive power pads can be changed as part of the IC package footprint definition.

The electronic device 100 also includes several circular conductive pads 113 that are formed in a region of the surface of electronic device 100 that surrounds regions 101-102, as shown in FIG. 1A. In addition, electronic device 100 includes several non-circular elliptically shaped conductive pads 114 that are formed on the surface of electronic device 100 in rows that surround conductive pads 113. The rows of pads 114 are next to the 4 sides of conductive pads 113, as shown in FIG. 1A. When electronic device 100 is coupled in or to an IC package, one or more input and/or output signals (e.g., data signals, clock signals, control signals) can be transmitted between the electronic device 100 and another device through the conductive pads 113 and 114. Thus, the conductive pads 113 and 114 function as signal pads.

FIG. 1B is a diagram that depicts another example of an electronic device 130 having non-circular elliptically shaped conductive power pads. The electronic device 130 can be, as examples, a circuit board (e.g., a printed circuit board), an integrated circuit (IC) die, a package substrate in an IC package, or an interposer. The electronic device 130 can be used to transmit, store, and/or process electronic signals and to transmit and/or receive power supply and/or ground voltages. The electronic device 130 is also referred to as an electrical device.

The electronic device 130 includes 66 oval conductive pads 131 and 40 circular conductive pads 132. Only a subset of the conductive pads 131-132 are labeled with reference numerals in FIG. 1B to simplify the drawing. Each of the conductive pads 131-132 is formed on a surface of the electronic device 130. Thus, each of the conductive pads 131-132 is exposed on the surface of electronic device 130, and can be used as a point of electrical contact from electronic device 130 to another electrical device, such as an IC package, package substrate, IC die, or circuit board. Each of the conductive pads 131-132 is made of conductive material. The conductive pads 131-132 can be coupled to another device through conductive connections (e.g., conductive bumps or balls) that have the same shapes as the conductive pads 131-132.

The oval pads 131 are formed in two rectangular regions that are surrounded by the circular pads 132. Each of the conductive pads 131 is shaped as a non-circular ellipse having two foci F1 and F2 that are in different locations (F1≠F2) in the view of FIG. 1B. Thus, each of the conductive pads 131 has the shape of an ellipse having a major axis through two foci F1 and F2 of the ellipse that is longer than a minor axis of the ellipse.

When the electronic device 130 is coupled in a circuit system, one or more power supply voltages and/or ground voltages can be transmitted through the oval conductive pads 131 into and/or out of the electronic device 130. Thus, conductive pads 131 function as power supply voltage and/or ground voltage delivery pads for delivering one or more power supply voltages and/or one or more ground voltages and associated power supply current and/or ground current to and/or from the electronic device 130. Also, when electronic device 130 is coupled in a circuit system, one or more input and/or output signals (e.g., data signals, clock signals, control signals) can be transmitted between electronic device 130 and another device through the conductive pads 132. Thus, the conductive pads 132 function as signal pads.

FIG. 1C is a diagram that depicts another example of an electronic device 150 having non-circular elliptically shaped conductive power pads. The electronic device 150 can be, as examples, a circuit board (e.g., a printed circuit board), an integrated circuit (IC) die, a package substrate in an IC package, or an interposer. The electronic device 150 can be used to transmit, store, and/or process electronic signals and to transmit and/or receive power supply and/or ground voltages. The electronic device 150 is also referred to as an electrical device.

The electronic device 150 includes 40 oval conductive pads 151 and 77 circular conductive pads 152. Only a subset of the conductive pads 151-152 are labeled with reference numerals in FIG. 1C to simplify the drawing. Each of the conductive pads 151-152 is formed on a surface of the electronic device 150. Thus, each of the conductive pads 151-152 is exposed on the surface of electronic device 150, and can be used as a point of electrical contact from electronic device 150 to another electrical device, such as an IC package, package substrate, IC die, or circuit board. Each of the conductive pads 151-152 is made of conductive material. The conductive pads 151-152 can be coupled to another device through conductive connections (e.g., conductive bumps or balls) that have the same shapes as the conductive pads 151-152.

The circular pads 152 are formed in a rectangular region surrounded by the oval pads 151. Each of the conductive pads 151 is shaped as a non-circular ellipse having two foci F1 and F2 that are in different locations (F1≠F2) in the view of FIG. 1C. When the electronic device 150 is coupled in a circuit system, one or more power supply voltages and/or ground voltages can be transmitted through the oval conductive pads 151 into and/or out of the electronic device 150. Thus, conductive pads 151 function as power supply voltage and/or ground voltage delivery pads for delivering one or more power supply voltages and/or one or more ground voltages and associated power supply current and/or ground current to and/or from the electronic device 150. Also, when electronic device 150 is coupled in a circuit system, one or more input and/or output signals (e.g., data signals, clock signals, control signals) can be transmitted between electronic device 150 and another device through the conductive pads 152. Thus, the conductive pads 152 function as signal pads.

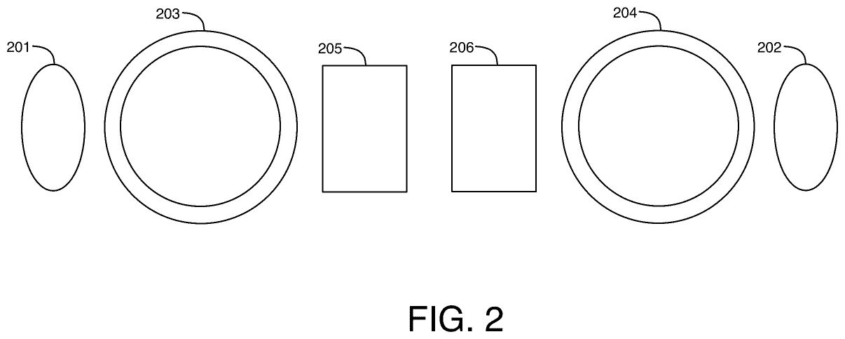

FIG. 2 is a diagram that depicts a top down view of examples of non-circular elliptically shaped conductive power pads 201-202, power through vias 203-204, and rectangularly shaped conductive pads 205-206 for capacitors in a circuit board. The non-circular elliptically shaped conductive pads 201-202 are formed on the top surface of a circuit board. The circuit board of FIG. 2 can be, as examples, any of the electronic devices 100, 130, or 150 of FIGS. 1A-1C. The non-circular elliptically shaped conductive pads 201-202 can be, as examples, any two of conductive pads 111 or 112 of FIG. 1A, pads 131 of FIG. 1B, or pads 151 of FIG. 1C. The conductive pads 201 and 202 function as power supply voltage and/or ground voltage delivery pads for delivering one or more power supply voltages and/or ground voltages and associated power supply current or ground current from the circuit board to an IC package.

The power through vias 203-204 are holes that are formed inside the circuit board. The power through vias 203-204 are formed through a portion of the thickness of the circuit board. The power through vias 203-204 are typically filled with conductive material. The rectangularly shaped conductive pads 205-206 are formed on the bottom surface of the circuit board. The conductive material in the power through via 203 can couple the conductive pad 201 to the conductive pad 205 through conductors (not shown) in other layers of the circuit board. The conductive material in the power through via 204 can couple the conductive pad 202 to the conductive pad 206 through conductors (not shown) in other layers of the circuit board.

The rectangularly shaped conductive pads 205-206 can, for example, be coupled to capacitors at the bottom surface of the circuit board. The capacitors can be used to store charge for one or more power supply voltages and/or ground voltages. The power supply voltages and/or ground voltages (and supply current for the power supply and/or ground voltages) can be delivered from the capacitors through the conductive pads 205-206, through the conductive material in the power through vias 203-204, and through the elliptically shaped conductive pads 201-202, respectively, to an integrated circuit (IC) in the IC package.

Because the conductive pads 201-202 are narrow along their minor axes relative to circular pads having the same major axis, the power through vias 203-204 are offset from the conductive pads 205-206, such that the power through vias 203-204 do not overlap the conductive pads 205-206, respectively, in the top down view of FIG. 2. Thus, the narrow widths of the elliptically shaped conductive pads 201-202 provide enough space for the power through vias 203-204 to be located between conductive pads 201-202 and conductive pads 205-206, respectively, as shown in FIG. 2, without overlap. As a result, the oval shaped power pads 201-202 can optimize the power and ground delivery and the circuit board placement of the capacitors.

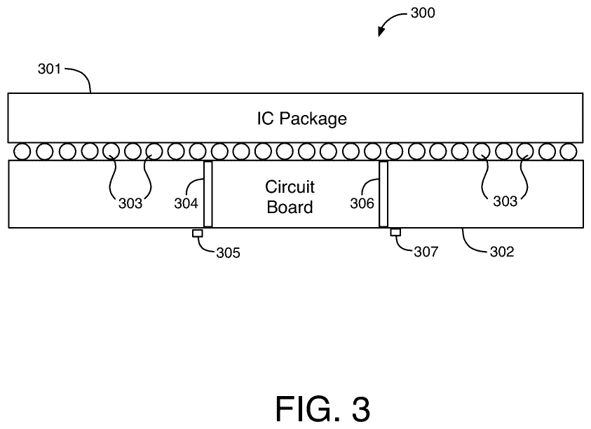

FIG. 3 is a diagram that illustrates a cross sectional view of an example of a circuit system 300 that includes an integrated circuit (IC) package 301 coupled to a circuit board 302. The circuit board 302 can include, for example, the conductive pads of any of the electronic devices 100, 130, or 150 shown in FIGS. 1A-1C. IC package 301 is coupled to circuit board 302 through conductive balls 303 (e.g., solder balls). Each of the conductive balls 303 is coupled to a conductive pad on the top surface of the circuit board 302 and to a conductive pad on the bottom surface of the IC package 301. The IC package 301 includes a substrate and an IC die. The substrate and/or the IC die in IC package 301 can include, for example, the conductive pads of any of the electronic devices 100, 130, or 150 of FIGS. 1A-1C.

As an example, circuit board 302 can include oval shaped (e.g., non-circular elliptically shaped) conductive pads that are used for the delivery of one or more power supply voltages and/or ground voltages from the circuit board 302 (e.g., from capacitors) to the IC die in IC package 301. These oval shaped conductive pads are formed on the top surface of the circuit board 302 and are coupled to a subset of the conductive balls 303. A power supply voltage can be delivered from a capacitor 305 coupled to a conductive pad (such as one of pads 205-206) on the bottom surface of circuit board 302 through conductive material in power through via 304 (e.g., one of vias 203-204) and through a non-circular elliptically shaped conductive pad (such as one of pads 201-202) on the top surface of circuit board 302 to IC package 301. As another example, a ground voltage or a second supply voltage can be delivered from a capacitor 307 coupled to a conductive pad (such as one of pads 205-206) on the bottom surface of circuit board 302 through conductive material in power through via 306 (e.g., one of vias 203-204) and through a non-circular elliptically shaped conductive pad (such as one of pads 201-202) on the top surface of circuit board 302 to IC package 301. As other examples, the IC die and/or the substrate in IC package 301 can also include oval power delivery pads as shown, for example, in FIGS. 1A-1C.

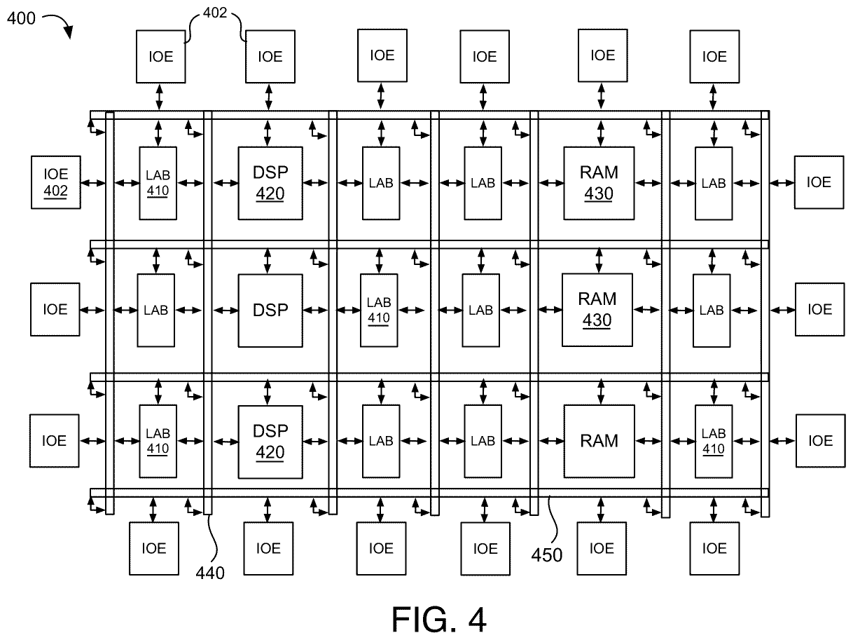

FIG. 4 is a diagram of an illustrative example of a configurable integrated circuit (IC) 400. Configurable IC 400 is an example of an IC that can be in the IC package 301 disclosed herein with respect to FIG. 3 and/or any of the electronic devices 100, 130, or 150 of FIGS. 1A-1C. As shown in FIG. 4, the configurable integrated circuit 400 includes a two-dimensional array of configurable logic circuit blocks, including logic array blocks (LABs) 410 and other configurable logic circuit blocks, such as random access memory (RAM) blocks 430 and digital signal processing (DSP) blocks 420, for example. Configurable logic circuit blocks, such as LABs 410, can include smaller configurable regions (e.g., configurable logic elements, configurable logic blocks, or adaptive logic modules (ALMs)) that receive input signals and perform custom functions on the input signals to produce output signals.

The configurable integrated circuit 400 also includes programmable interconnect circuitry in the form of vertical routing channels 440 (i.e., interconnects formed along a vertical axis of configurable integrated circuit 400) and horizontal routing channels 450 (i.e., interconnects formed along a horizontal axis of configurable integrated circuit 400), each routing channel including at least one track to route at least one wire. One or more of the routing channels 440 and/or 450 can be part of a network-on-chip (NOC) having router circuits.

In addition, the configurable integrated circuit 400 has input/output elements (IOEs) 402 for driving signals off of configurable integrated circuit 400 and for receiving signals from other devices. Input/output elements 402 can include parallel input/output circuitry, serial data transceiver circuitry, differential receiver and transmitter circuitry, or other circuitry used to connect one integrated circuit to another integrated circuit. Input/output elements 402 can include general purpose input/output (GPIO) circuitry (e.g., on the top and bottoms edges of IC 400), high-speed input/output (HSIO) circuitry (e.g., on the left edge of IC 400), and on-package input/output (OPIOs) circuitry (e.g., on the right edge of IC 400).

As shown, input/output elements 402 can be located around the periphery of the IC. If desired, the configurable integrated circuit 400 can have input/output elements 402 arranged in different ways. For example, input/output elements 402 can form one or more columns of input/output elements that can be located anywhere on the configurable integrated circuit 400 (e.g., distributed evenly across the width of the configurable integrated circuit). If desired, input/output elements 402 can form one or more rows of input/output elements (e.g., distributed across the height of the configurable integrated circuit). Alternatively, input/output elements 402 can form islands of input/output elements that can be distributed over the surface of the configurable integrated circuit 400 or clustered in selected areas.

Note that other routing topologies, besides the topology of the interconnect circuitry depicted in FIG. 4, can be used. For example, the routing topology can include wires that travel diagonally or that travel horizontally and vertically along different parts of their extent as well as wires that are perpendicular to the device plane in the case of three dimensional integrated circuits, and the driver of a wire can be located at a different point than one end of a wire. The routing topology can include global wires that span substantially all of configurable integrated circuit 400, fractional global wires such as wires that span part of configurable integrated circuit 400, staggered wires of a particular length, smaller local wires, or any other suitable interconnection resource arrangement.

Furthermore, it should be understood that examples disclosed herein may be implemented in any type of integrated circuit. If desired, the functional blocks of such an integrated circuit can be arranged in more levels or layers in which multiple functional blocks are interconnected to form still larger blocks. Other device arrangements can use functional blocks that are not arranged in rows and columns.

Configurable integrated circuit 400 can also contain programmable memory elements. The memory elements can be loaded with configuration data (also called programming data) using input/output elements (IOEs) 402. Once loaded, the memory elements each provide a corresponding static control signal that controls the operation of an associated functional block (e.g., LABs 410, DSP 420, RAM 430, or input/output elements 402).

In a typical scenario, the outputs of the loaded memory elements are applied to the gates of field-effect transistors in a functional block to turn certain transistors on or off and thereby configure the logic in the functional block including the routing paths. Programmable logic circuit elements that are controlled in this way include parts of multiplexers (e.g., multiplexers used for forming routing paths in interconnect circuits), look-up tables, logic arrays, AND, OR, NAND, and NOR logic gates, pass gates, etc.

The memory elements can use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory or programmable memory elements.

The programmable memory elements can be organized in a configuration memory array consisting of rows and columns. A data register that spans across all columns and an address register that spans across all rows can receive configuration data. The configuration data can be shifted onto the data register. When the appropriate address register is asserted, the data register writes the configuration data to the configuration memory elements of the row that was designated by the address register.

Configurable integrated circuit 400 can include configuration memory that is organized in sectors, whereby a sector can include the configuration bits that specify the function and/or interconnections of the subcomponents and wires in or crossing that sector. Each sector can include separate data and address registers.

The configurable IC 400 of FIG. 4 is merely one example of an IC that can be used with embodiments disclosed herein. The embodiments disclosed herein can be used with any suitable electronic integrated circuit or system. For example, the embodiments disclosed herein can be used with numerous types of electronic devices such as processor integrated circuits, central processing units, memory integrated circuits, graphics processing unit integrated circuits, application specific standard products (ASSPs), application specific integrated circuits (ASICs), and configurable logic integrated circuits. Examples of configurable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

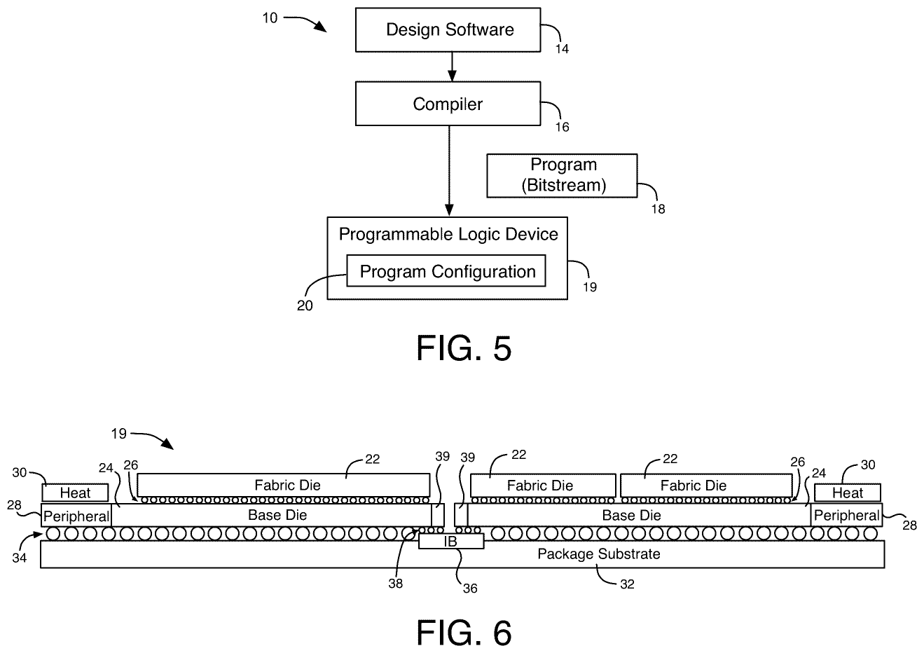

FIG. 5 illustrates a block diagram of a system 10 that can be used to implement a circuit design to be programmed onto a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized task.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 6, but many others can be used, and it should be understood that this disclosure is intended to encompass any suitable programmable logic device where programmable logic fabric and fabric support circuitry are at least partially separated on different integrated circuit die.

FIG. 6 is a diagram that depicts an example of the programmable logic device 19 that includes three fabric die 22 and two base die 24 that are connected to one another via microbumps 26. In the example of FIG. 6, at least some of the programmable logic fabric of the programmable logic device 19 is in the three fabric die 22, and at least some of the fabric support circuitry that operates the programmable logic fabric is in the two base die 24. For example, some of the circuitry of configurable IC 400 shown in FIG. 4 (e.g., LABs 410, DSP 420, and RAM 430) can be located in the fabric die 22 and some of the circuitry of IC 400 (e.g., input/output elements 402) can be located in the base die 24.

Although the fabric die 22 and base die 24 appear in a one-to-one relationship or a two-to-one relationship in FIG. 6, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 19. The heat spreaders 30 can appear above, as pictured, and/or below the package (e.g., as a double-sided heat sink). The base die 24 can attach to a package substrate 32 via conductive bumps 34. In the example of FIG. 6, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 19 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

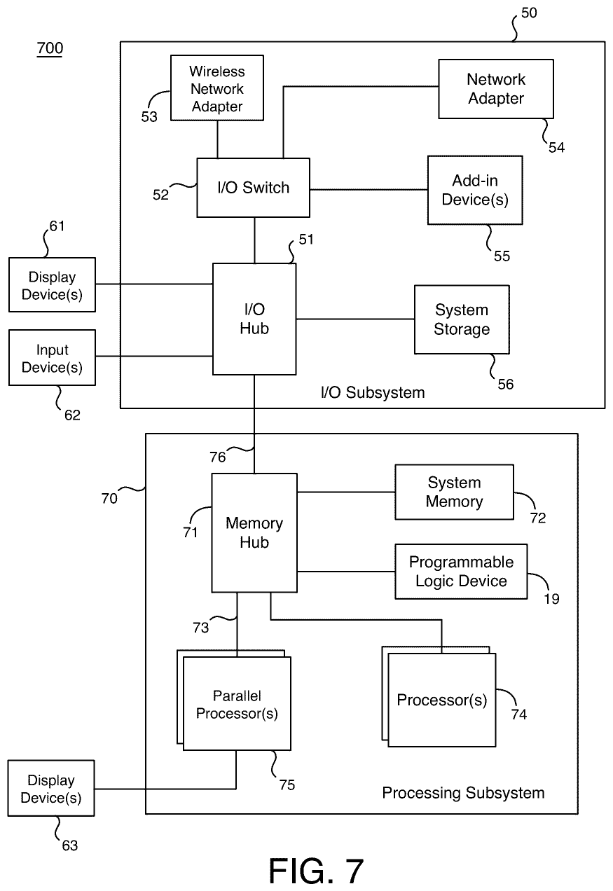

FIG. 7 is a block diagram illustrating a computing system 700 configured to implement one or more aspects of the embodiments described herein. The computing system 700 includes a processing subsystem 70 having one or more processor(s) 74, a system memory 72, and a programmable logic device 19 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 700 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 700. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 700 can include other components not shown in FIG. 7, including other port connections, optical storage drives, video capture devices, and the like, that can also be connected to the I/O hub 51. Communication paths interconnecting the various components in FIG. 7 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 700 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 700 can be integrated into a single package to form a system in package (SIP) configuration. In one embodiment, at least a portion of the components of the computing system 700 can be integrated into a multi-chip module (MCM), which can be interconnected with other multi-chip modules into a modular computing system.

The computing system 700 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 700. For example, any number of add-in cards or peripherals can be supported, or some components can be eliminated. Furthermore, some architectures can use different terminology for components similar to those illustrated in FIG. 7. For example, the memory hub 71 can be referred to as a Northbridge in some architectures, while the I/O hub 51 can be referred to as a Southbridge.

Additional examples are now described. Example 1 is an electronic device comprising: first conductive pads on a first surface of the electronic device, wherein each of the first conductive pads has an oval shape, and wherein the first conductive pads are coupled to deliver at least one of a power supply voltage or a ground voltage between an external device and the electronic device.

In Example 2, the electronic device of Example 1 can optionally include, wherein the electronic device is an integrated circuit die.

In Example 3, the electronic device of Example 1 can optionally include, wherein the electronic device is a package substrate of an integrated circuit package.

In Example 4, the electronic device of any one of Examples 1-3 further comprises: power through vias; and second conductive pads on a second surface of the electronic device that is opposite the first surface, wherein the first conductive pads are coupled through conductive material in the power through vias to the second conductive pads.

In Example 5, the electronic device of Example 4 can optionally include, wherein the second conductive pads are coupled to capacitors, wherein the second conductive pads are non-overlapping with the power through vias.

In Example 6, the electronic device of any one of Examples 1-5 can optionally include, wherein the first conductive pads are coupled to provide the power supply voltage between the electronic device and an integrated circuit package.

In Example 7, the electronic device of any one of Examples 1-6 can optionally include, wherein the first conductive pads are coupled to provide multiple power supply voltages between the electronic device and the external device.

In Example 8, the electronic device of any one of Examples 1-7 further comprises: second conductive pads on the first surface of the electronic device, wherein the second conductive pads are coupled to provide input and output signals between the electronic device and the external device, and wherein the second conductive pads have oval shapes and surround the first conductive pads.

In Example 9, the electronic device of any one of Examples 1-8 can optionally include, wherein each of the first conductive pads has an elliptical shape comprising a major axis and a minor axis, and wherein the major axis of each of the first conductive pads is longer than the minor axis of that one of the first conductive pads.

Example 10 is a method for delivering power between an electronic device and an external device, the method comprising: coupling the electronic device to the external device through first conductive pads on a surface of the electronic device, wherein the first conductive pads have non-circular elliptical shapes; and transmitting a power supply voltage between the electronic device and the external device through at least one of the first conductive pads.

In Example 11, the method of Example 10 can optionally include, wherein the electronic device is an integrated circuit die.

In Example 12, the method of Example 10 can optionally include, wherein the electronic device is a package substrate of an integrated circuit package.

In Example 13, the method of Example 10 can optionally include, wherein the electronic device is a circuit board.

In Example 14, the method of any one of Examples 10-13 further comprises: storing charge for the power supply voltage in a capacitor coupled to a power through via in the electronic device; and transmitting the power supply voltage from the capacitor through the power through via and through the at least one of the first conductive pads to the external device.

In Example 15, the method of any one of Examples 10-14 further comprises: providing input and output signals between the electronic device and the external device through second conductive pads on the surface of the electronic device, wherein the second conductive pads have the non-circular elliptical shapes.

Example 16 is a circuit system comprising: an electrical device comprising first conductive pads on a first surface of the electrical device, wherein the first conductive pads are coupled to an external device, wherein each one of the first conductive pads has a major axis and a minor axis, wherein the major axis of each one of the first conductive pads is longer than the minor axis of the respective one of the first conductive pads, and wherein the first conductive pads are coupled to provide a power supply voltage between the electrical device and the external device.

In Example 17, the circuit system of Example 16 can optionally include, wherein the electrical device is an integrated circuit.

In Example 18, the circuit system of Example 16 can optionally include, wherein the electrical device is a package substrate in an integrated circuit package.

In Example 19, the circuit system of Example 16 can optionally include, wherein the electrical device is a circuit board.

In Example 20, the circuit system of any one of Examples 16-19 can optionally include, wherein the electrical device further comprises: power through vias; and second conductive pads on a second surface of the electrical device, wherein the second conductive pads are coupled to capacitors, and wherein the first conductive pads are coupled through conductive material in the power through vias to the second conductive pads.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. An electronic device comprising:
first conductive pads on a first surface of the electronic device, wherein each of the first conductive pads has an oval shape, and wherein the first conductive pads are coupled to deliver at least one of a power supply voltage or a ground voltage between an external device and the electronic device.

2. The electronic device of claim 1, wherein the electronic device is an integrated circuit die.

3. The electronic device of claim 1, wherein the electronic device is a package substrate of an integrated circuit package.

4. The electronic device of claim 1 further comprising:
power through vias; and
second conductive pads on a second surface of the electronic device that is opposite the first surface, wherein the first conductive pads are coupled through conductive material in the power through vias to the second conductive pads.

5. The electronic device of claim 4, wherein the second conductive pads are coupled to capacitors, wherein the second conductive pads are non-overlapping with the power through vias, and wherein the electronic device is a circuit board.

6. The electronic device of claim 1, wherein the first conductive pads are coupled to provide the power supply voltage between the electronic device and an integrated circuit package.

7. The electronic device of claim 1, wherein the first conductive pads are coupled to provide multiple power supply voltages between the electronic device and the external device.

8. The electronic device of claim 1 further comprising:
second conductive pads on the first surface of the electronic device, wherein the second conductive pads are coupled to provide input and output signals between the electronic device and the external device, and wherein the second conductive pads have oval shapes and surround the first conductive pads.

9. The electronic device of claim 1, wherein each of the first conductive pads has an elliptical shape comprising a major axis and a minor axis, and wherein the major axis of each of the first conductive pads is longer than the minor axis of that one of the first conductive pads.

10. A method for delivering power between an electronic device and an external device, the method comprising:
coupling the electronic device to the external device through first conductive pads on a surface of the electronic device, wherein the first conductive pads have non-circular elliptical shapes; and
transmitting a power supply voltage between the electronic device and the external device through at least one of the first conductive pads.

11. The method of claim 10, wherein the electronic device is an integrated circuit die.

12. The method of claim 10, wherein the electronic device is a package substrate of an integrated circuit package.

13. The method of claim 10, wherein the electronic device is a circuit board.

14. The method of claim 10 further comprising:
storing charge for the power supply voltage in a capacitor coupled to a power through via in the electronic device; and
transmitting the power supply voltage from the capacitor through the power through via and through the at least one of the first conductive pads to the external device.

15. The method of claim 10 further comprising:
providing input and output signals between the electronic device and the external device through second conductive pads on the surface of the electronic device, wherein the second conductive pads have the non-circular elliptical shapes.

16. A circuit system comprising:
an electrical device comprising first conductive pads on a first surface of the electrical device, wherein the first conductive pads are coupled to an external device, wherein each one of the first conductive pads has a major axis and a minor axis, wherein the major axis of each one of the first conductive pads is longer than the minor axis of the respective one of the first conductive pads, and wherein the first conductive pads are coupled to provide a power supply voltage between the electrical device and the external device.

17. The circuit system of claim 16, wherein the electrical device is an integrated circuit.

18. The circuit system of claim 16, wherein the electrical device is a package substrate in an integrated circuit package.

19. The circuit system of claim 16, wherein the electrical device is a circuit board.

20. The circuit system of claim 19, wherein the electrical device further comprises:
power through vias; and
second conductive pads on a second surface of the electrical device, wherein the second conductive pads are coupled to capacitors, and wherein the first conductive pads are coupled through conductive material in the power through vias to the second conductive pads.
